(19) United States
(12) Patent Application Publication
(10) Pub. No.: US 2024/0336470 A1
(43) Pub. Date: Oct. 10, 2024

(54) PRESSURIZED FLUID DISPENSER

(71) Applicant: Starbucks Corporation, Seattle, WA (US)

(72) Inventors: Ryan T. Bell, Mill Creek, WA (US); John L. Brockman, Edmonds, WA (US); John Newton, Sebastian, FL (US); Jake Lockwood, Bayville, NJ (US); Gillian Callaghan, Vero Beach, FL (US)

(21) Appl. No.: 18/625,572

(22) Filed: Apr. 3, 2024

Related U.S. Application Data
(60) Provisional application No. 63/494,585, filed on Apr. 6, 2023.

(51) Int. Cl. B67D 1/04; B67D 1/12

(52) U.S. Cl. CPC B67D 1/0462; B67D 1/1281

(57) ABSTRACT

Various methods devices and systems are disclosed herein related to a fluid dispenser that includes a container that includes an inlet and an outlet. The container defines an inner volume. A pressure-actuated outlet valve is also provided adjacent the outlet and movable between an open position and a closed position. The outlet valve is biased toward the closed position and configured to move to the open position upon receiving a threshold pressure from the inner volume. The container can include a bag receiver. The bag receiver can hold a flexible container in the inner volume.

### INCORPORATION BY REFERENCE TO ANY PRIORITY APPLICATIONS

This application claims priority to U.S. Provisional Patent Application No. 63/494,585, filed Apr. 6, 2023, the entirety of which is incorporated herein by reference.

### FIELD

The present disclosure relates to systems and methods for dispensing beverages, such as, systems, devices, and methods for dispensing liquid from a pressurized container.

### BACKGROUND

Beverages prepared in homes or restaurants such as a coffee store can include fluid ingredients added from a fluid dispenser. For example, beverages can include ingredients such as coffee, milk, water, tea, and syrup, which can be distributed through a fluid dispenser. Conventionally, a beverage dispenser can utilize a pump to dispense beverages.

### SUMMARY

For purposes of this summary, certain aspects, advantages, and novel features are described herein. It is to be understood that not necessarily all such advantages may be achieved in accordance with any particular embodiment. Thus, for example, those skilled in the art will recognize the disclosures herein may be embodied or carried out in a manner that achieves one or more advantages taught herein without necessarily achieving other advantages as may be taught or suggested herein.

In some embodiments, a fluid dispenser can include a container including an inlet and an outlet, the container can define an inner volume; a pressure-actuated outlet valve adjacent the outlet and movable between an open position and a closed position; and a flexible fluid container positioned within the container and including an outlet passage that can extend through the pressure-actuated outlet valve, the outlet valve can be biased toward the closed position and configured to move to the open position when the pressure within the inner volume and applied to the flexible fluid container exceeds a threshold pressure.

In some embodiments, the outlet valve can be configured to return to the closed position when the pressure in the inner volume is less than the threshold pressure.

In some embodiments, the outlet passage can be disposed in the outlet, such that fluid within the flexible container does not contact the outlet of the container.

In some embodiments, the flexible fluid container can further include an elongated neck portion.

In some embodiments, the outlet valve is disposed about at least a portion of the neck, wherein the outlet valve is positioned to restrict fluid flow through at least a portion of the neck.

In some embodiments, the interior volume of the flexible container can be in fluidic communication with the outlet when the outlet valve is in the open position, and the interior volume of the flexible container can be fluidically isolated from the outlet when the outlet valve is in the closed position.

In some embodiments, the flexible container can be fluidically isolated from the inner volume of the container.

In some embodiments, the container can further include a bag receiver configured to slidably receive at least a portion of the neck, and the bag receiver can be configured to secure the opening of the flexible container relative to the outlet of the container.

In some embodiments, the inlet of the container can be configured to be coupled to a pressurized fluid source.

In some embodiments, the container can further include an openable cap including the outlet.

In some embodiments, the fluid dispenser can further include an inlet valve adjacent the inlet.

In some embodiments, the inlet can be fluidically sealed when the inlet valve is in the closed position, and the inlet can be fluidically open when the inlet valve is in the open position.

In some embodiments, a fluid dispensing system can include a container system including a container including an inlet and an outlet, the container can define an inner volume; and a pressure-actuated outlet valve adjacent the outlet and movable between an open position and a closed position, the outlet valve can be biased toward the closed position and configured to move to the open position upon receiving a threshold pressure from the inner volume; and a pressurized fluid source in fluidic communication with the inlet of the container.

In some embodiments, the outlet valve can be configured to return to the closed position upon receiving pressure less than the threshold pressure from the inner volume.

In some embodiments, the outlet can be fluidically sealed when the outlet valve is in the closed position, and the outlet can be fluidically open when the outlet valve is in the open position.

In some embodiments, the inner volume can be in fluidic communication with the outlet when the outlet valve is in the open position, and the inner volume can be fluidically isolated from the outlet when the outlet valve is in the closed position.

In some embodiments, the system can further include a flexible container defining an interior volume and an opening, the flexible container can be disposed inside the inner volume, and the opening can be adjacent the outlet of the container.

In some embodiments, the interior volume of the flexible container can be in fluidic communication with the outlet when the outlet valve is in the open position, and the interior volume of the flexible container can be fluidically isolated from the outlet when the outlet valve is in the closed position.

In some embodiments, the system can further include a processor in communication with the pressurized fluid source.

In some embodiments, the system can further include an inlet valve in communication with the processor, the inlet valve can be moved between an open position and a closed position based on instructions from the processor.

In some embodiments, the system can further include one or more container systems coupled to the pressurized fluid source.

In some embodiments, a method of dispensing a fluid from a dispensing system can include receiving instructions to dispense fluid from a dispensing system, increasing the pressure above threshold pressure in an inner volume of a container containing a flexible fluid container, wherein fluid inside the flexible container can be expelled through a pressure-actuated outlet valve by the threshold pressure, wherein the outlet valve can be configured to move from a closed position to open position upon receiving fluid at the threshold pressure, receiving instructions to stop dispensing fluid, and decreasing the pressure within the container below the threshold pressure.

In some embodiments, increasing the pressure above the threshold pressure in the inner volume can include opening an inlet valve into the inner volume.

In some embodiments, a fluid dispenser can include a container including an inlet and an outlet, the container can define an inner volume; a pressure-actuated outlet valve adjacent the outlet and movable between an open position and a closed position; a flexible fluid container positioned within the container and including an outlet passage that can extend through the pressure-actuated outlet valve; and a bag receiver positioned in the container, the bag receiver can be configured to slidably receive at least a portion of the flexible fluid container to secure the outlet of the flexible fluid container relative to the outlet of the container, the outlet valve can be biased toward the closed position and configured to move to the open position when the pressure within the inner volume and applied to the flexible fluid container exceeds a threshold pressure.

In some embodiments, a fluid dispenser, the outlet valve can be configured to return to the closed position when the pressure in the inner volume is less than the threshold pressure.

In some embodiments, the outlet passage can be disposed in the outlet, such that fluid within the flexible container does not contact the outlet of the container.

In some embodiments, the flexible fluid container can further include an elongated neck portion.

In some embodiments, the outlet valve can be disposed about at least a portion of the neck, wherein the outlet valve is positioned to restrict fluid flow through at least a portion of the neck.

In some embodiments, the interior volume of the flexible container can be in fluidic communication with the outlet when the outlet valve is in the open position, and wherein the interior volume of the flexible container can be fluidically isolated from the outlet when the outlet valve is in the closed position.

In some embodiments, the bag receiver can include a u-shaped receiver configured to receive at least the portion of the flexible fluid container.

In some embodiments, the bag receiver can be removably coupled to the container.

In some embodiments, the inlet of the container can be configured to be coupled to a pressurized fluid source.

In some embodiments, the container can further include an openable cap including the outlet.

In some embodiments, the fluid dispenser can further include an inlet valve adjacent the inlet.

In some embodiments, the inlet can be fluidically sealed when the inlet valve is in the closed position, and wherein the inlet is fluidically open when the inlet valve is in the open position.

In some embodiments, a fluid dispensing system can include a plurality of container systems, each container system including a container including an inlet and an outlet, the container can define an inner volume; a pressure-actuated outlet valve adjacent the outlet and movable between an open position and a closed position; and a bag receiver positioned in the inner volume of the container, the bag receiver can be configured to slidably receive at least a portion of a flexible container and secure an opening of the flexible container relative to the outlet of the container, the outlet valve can be biased toward the closed position and configured to move to the open position upon receiving a threshold pressure from the inner volume; and a pressurized fluid source in fluidic communication with the inlet of the container of each container system.

In some embodiments, the outlet valve can be configured to return to the closed position upon receiving pressure less than the threshold pressure from the inner volume.

In some embodiments, the outlet can be fluidically sealed when the outlet valve is in the closed position, and the outlet can be fluidically open when the outlet valve is in the open position.

In some embodiments, the inner volume can be in fluidic communication with the outlet when the outlet valve is in the open position, and the inner volume can be fluidically isolated from the outlet when the outlet valve is in the closed position.

In some embodiments, the system can further include the flexible container defining an interior volume and an opening, the flexible container can be disposed inside the inner volume, and the opening can be adjacent the outlet of the container.

In some embodiments, the interior volume of the flexible container can be in fluidic communication with the outlet when the outlet valve is in the open position, and the interior volume of the flexible container can be fluidically isolated from the outlet when the outlet valve is in the closed position.

In some embodiments, the system can further include a processor in communication with the pressurized fluid source.

In some embodiments, the system can further include an inlet valve in communication with the processor, the inlet valve can be moved between an open position and a closed position based on instructions from the processor.

In some embodiments, the bag receiver of each container system can include a u-shaped receiver configured to receive at least the portion of the flexible fluid container.

### BRIEF DESCRIPTION OF THE DRAWINGS

FIG. 1 illustrates a cut-away side view of an example fluid dispensing system that includes a fluid dispenser of FIG. 1.

FIG. 2 illustrates a perspective view of an example of the fluid dispenser shown in FIG. 1.

FIG. 3 shows an example fluid dispensing system that includes a plurality of fluid dispensers such as the fluid dispenser shown in FIG. 1.

FIG. 4 schematically illustrates an example fluid dispensing system control system.

FIG. 5 shows flow chart illustrating example steps for a method of dispensing fluid.

FIG. 6 illustrates a perspective view of an example of the fluid dispenser shown in FIG. 1 with a bag receiver removed from an inner volume of the fluid dispenser.

Various embodiments are depicted in the accompanying drawings for illustrative purposes and should in no way be interpreted as limiting the scope of the embodiments. Furthermore, various features of different disclosed embodiments can be combined to form additional embodiments, which are part of this disclosure.

### DETAILED DESCRIPTION

Various dispenser systems, apparatuses, and methods are described below to illustrate various examples that may achieve one or more desired improvements. These examples are only illustrative and not intended in any way to restrict the general disclosure presented and the various aspects and features of this disclosure. The general principles described herein may be applied to embodiments and applications other than those discussed herein without departing from the spirit and scope of the disclosure. Indeed, this disclosure is not limited to the particular embodiments shown but is instead to be accorded the widest scope consistent with the principles and features that are disclosed or suggested herein.

Conventionally, fluids can be distributed for drink and/or food preparation using pressure driven fluid dispensers. Some fluid dispensers are pressurized such that fluid can be disbursed from the fluid dispenser into a container such as a serving container or beverage preparation device. The pressurized fluid dispensers can include a container that is disposed around a flexible container and maintained in a pressurized state. The flexible container can be a bag that holds the fluid to be disbursed. The flexible bag can include an outlet that is restricted by a movable valve.

Some valves can include an electronics assembly so that the valve can be electronically actuated. The valve can be disposed in a cap of the container. The cap can be removable to allow the bag to be replaced. As such, portions of the electronics assembly can thus be integrated into the cap. However, some portions of the electronic assembly are disconnected and/or removed when the cap is to be opened such as to replace the bag, which can be cumbersome. Additionally, cleaning of the cap and the assembled fluid dispenser can be cumbersome and/or impractical due to the integration of the electronics assembly, which typically should not be exposed to cleaning agents such as soap and water.

To solve such problems, fluid dispensing system according to embodiments of the present disclosure can be provided that includes a pressure-actuated valve at the outlet. The pressure-actuated valve can be a non-electronic valve such that the pressure-actuated valve can be coupled to and/or disposed in the cap without an electronics assembly. As such, the cap can be removed without removing and/or disconnecting portions of an electronic assembly. Additionally cleaning of the cap and the assembled fluid dispenser can be accomplished without removal or disconnection of portions of the electronics assembly and without damaging the fluid dispenser. The system can include an inlet valve disposed about the inlet so that pressure in an inner volume of the container can be controlled by the inlet valve to regulate the pressure around the bag and manage fluid dispensation.

### General

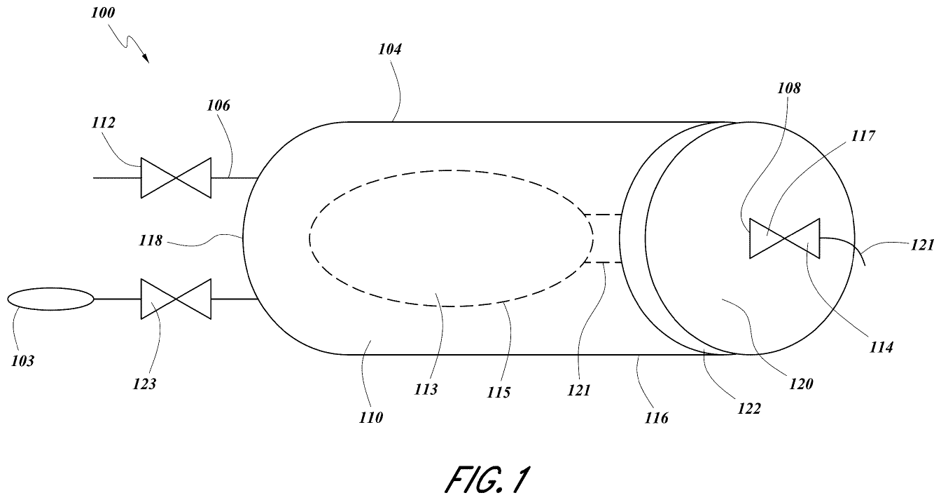

To address these and/or other concerns, disclosed herein are examples of fluid dispensers, systems, and methods for dispensing beverages. FIG. 1 shows an example of a fluid dispensing system 100. The example fluid dispensing system 100 includes a fluid dispenser 102 and a pressurized fluid source 103. The fluid dispenser 102 includes a container 104 that includes an inlet 106 and an outlet 108 and defines an inner volume 110. The fluid dispensing system 100 includes an inlet valve 112 adjacent the inlet 106, a pressure actuated outlet valve 114 adjacent the outlet 108, and a flexible container 113 disposed inside the inner volume 110 of the container 104.

### Container

FIG. 1 shows an example of the container 104. In this example, the container 104 is an enclosure that defines the inner volume 110 to provide a substantially fluidically sealed enclosure. The container 104 is provided to house a fluid and/or the flexible container 113 such that a desired fluid pressure can be regulated inside the container 104 through fluids conducted through the inlet 106 and the outlet 108 of the container 104. As such, the fluid pressure in the inner volume 110 can be maintained and adjusted through the inlet 106 and the outlet 108.

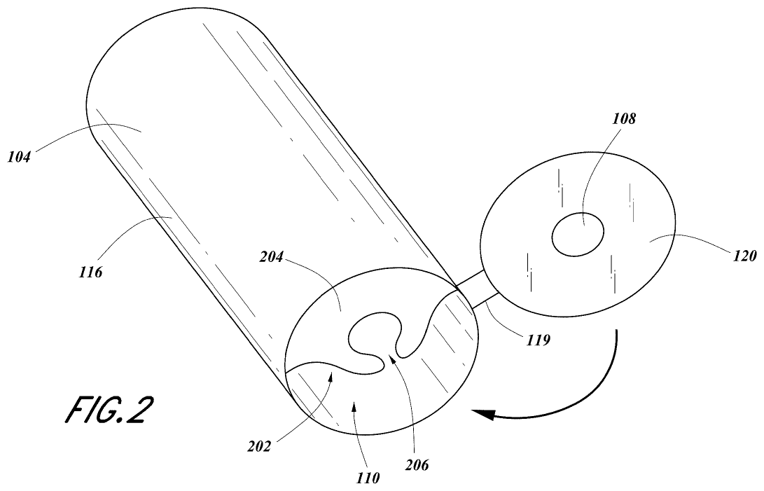

The container 104 includes an enclosure wall 116 having a first end and a second end. The container 104 further includes a base 118 coupled to the first end such that the wall 116 is disposed about an outer edge of the base 118, and a cap 120 disposed on the second end of the wall 116. The cap 120 can be movably coupled to the wall 116 such that the cap 120 can be disposed in an open position and a closed position. For example, as shown in FIG. 2, the cap 120 can be coupled to the wall 116 by a hinge 119, such that the cap 120 can swing open to expose the inner volume 110. Alternatively or additionally, the cap 120 can be completely removable from the rest of the container 104. When the cap 120 is in the open position, objects, such as a flexible container containing fluids, can be added to or removed from the inner volume through the first end of the wall 116. The cap 120 further provides a seal 122 when the cap 120 is in the closed position, such that the inner volume 110 is fluidically sealed within the fluid dispensing system 100. As such, compression fluids such as air can be restricted to enter and exit the inner volume 110 through the inlet 106 and the outlet 108 when the cap 120 is in the closed position.

In the example shown in FIG. 1, the container 104 is a substantially cylindrical shape, and the wall 116 is a substantially cylindrical wall. However, in some examples, the container 104 can be another substantially closed shape. For example, the container 104 can be a cuboid such that the wall 116 includes rectilinear sides and the base 118 is square or rectangular. In some examples, the container 104 is configured to be supported by the wall 116 during operation such that a central axis between the base 118 and the cap 120 is substantially parallel to a ground disposed relative to the container 104. In some examples, the container 104 is configured to be mounted to the base 118 such that the central axis between the base 118 and the cap 120 is substantially perpendicular to a plane of a ground disposed relative to the container 104.

### Inlet

FIG. 1 shows the inlet 106. The inlet 106 is provided to allow fluid, such as a pressurized gas (such as air or another gas), to pass into the inner volume 110 to provide a desired pressure. As shown in FIG. 1, the inlet 106 is an opening disposed in a portion of the container 104. The inlet 106 can also include a connector to receive a compressed fluid (e.g., air) line and secure the compressed fluid line thereto. In some examples, the compressed fluid line can be configured to withstand pressures of at least 25 psi. In some examples, the inlet 106 can include a seal such as a seal ring to maintain a substantially fluid-tight fit between the compressed fluid line and the inlet 106. In some examples, the inlet 106 is configured to receive a connection from the pressurized fluid source 103 such as a compressed fluid line of the pressurized fluid source 103. In the example shown in FIG. 1, the inlet 106 is disposed in the base 118 of the container 104. However, in some examples, the inlet 106 can be disposed alternatively or additionally in the wall 116 or the cap 120 of the container 104. In the example shown in FIG. 1, the container 104 includes one inlet 106, however in some examples, the container 104 can include a plurality of inlets 106.

### Outlet

FIG. 1 shows the outlet 108. The outlet 108 is provided to direct fluid from the container 104 and/or the flexible container 113 into a desired location such as a serving container or a beverage preparation device. For example, in the example shown in FIG. 1, the outlet 108 is an opening disposed in the cap 120 of the container 104. The outlet 108 can be disposed about at least a portion of the flexible container 113 to direct the shape of the flexible container. For example, the container 104 can include a spout that has a first portion, which extends perpendicular from the cap 120, and a second portion that extends from the first portion and perpendicular to the first portion. As such, the spout can point downwardly when the container 104 is resting on the wall 116. As such, the outlet 108 can be gravity assisted to direct at least a portion of the flexible container 113 in a desired direction. However, in some examples, the outlet 108 can be disposed alternatively or additionally in the wall 116 or the base 118 of the container 104. In the example shown in FIG. 1, the container 104 includes one outlet 108, however in some examples, the container 104 can include a plurality of outlets 108.

### Inlet Valve

The inlet valve 112 as shown in FIG. 1 provides a fluid control mechanism that can restrict and/or stop the flow of fluid through the inlet 106 into and out of the inner volume 110. The inlet valve 112 can be a valve such as a ball valve or a duck valve. The inlet valve 112 is disposable in an open position and a closed position. When in the open position, fluid can pass through the inlet valve 112 and through the inlet 106 into and out of the inner volume 110. When in the closed position the inlet valve 112 can restrict fluid flow through the inlet 106 such that fluid cannot pass between the inner volume 110 and past the inlet 106. In some examples, the inlet valve 112 can be controlled remotely such that the inlet valve 112 can be opened and closed based on direct user input. For example, the inlet valve 112 can be an electronically actuated valve that is coupled to a motor. In some examples, the inlet valve 112 can be a manually actuated valve coupled to an actuation mechanism such as a switch or a lever that can be pulled or pressed by a user to move the inlet valve 112 between the open position and the closed position. In some examples, the inlet valve 112 can be a pressure actuated valve that opens when a threshold pressure is applied thereto (e.g., constant flow valve such as the Newton CFiVe). In some examples, the pressure valve can be solenoid valve. In some examples, the solenoid valve can be used alone or in combination with the constant flow valve such that the solenoid valve opens and closes to allow the constant flow valve to modulate internal pressure as described herein. In some examples, the threshold pressure can be a pressure from about 10 psi to about 25 psi.

The inlet valve 112 can be disposed adjacent the inlet 106 such that when the inlet valve 112 is open, fluid can pass through the inlet 106, but when the inlet valve 112 is closed, then fluid cannot pass through the inlet 106. In some examples, the inlet valve 112 is disposed on an inner surface of the wall 116 of the container 104, and adjacent the inlet 106 such that the inlet 106 is obstructed from the inner volume 110 when the inlet valve 112 is in the closed position. In some examples, the inlet valve 112 can be disposed on an outer surface of the wall 116 of the container 104, and adjacent the inlet 106 such that the inlet 106 is obstructed from the inner volume 110 when the inlet valve 112 is in the closed position. In some examples, the inlet valve 112 is disposed in an inner circumference of the inlet 106 such that an outer edge of the inlet valve 112 abuts an inner edge of the inlet 106. As such, the inlet 106 can be obstructed from the inner volume 110 when the inlet valve 112 is in the closed position.

### Outlet Valve

The outlet valve 114 as shown in FIG. 1 provides a fluid control mechanism that stops the flow of fluid through the outlet 108 into and out of the inner volume 110. The outlet valve 114 can be a pressure actuated valve that opens when a threshold pressure is applied thereto. In some examples, the outlet valve 114 can be constant flow valves such as pinch valves. The outlet valve 114 can be a pressure sensitive valve such as a constant flow valve. The outlet valve 114 is disposable in an open position and a closed position. In the open position, fluid can pass through the outlet valve 114 and through the outlet 108 into and out of the inner volume 110 through the outlet 108. In the closed position, the outlet valve 114 restricts fluid flow through the outlet 108. The outlet valve 114 is configured to move to the open position upon receiving a threshold pressure from the inner volume 110. Further, the outlet valve 114 is biased toward the closed position such that the outlet valve 114 returns to the closed position when it does not receive a threshold pressure from the inner volume 110. For example, the pressure actuated valve can be a pinch valve that includes a plurality of opposing walls disposed substantially opposite each other about a seal body (e.g., a rubber seal tube). The walls can be biased toward each other to a closed position either by the application of fluid or mechanically by the body of the valve (e.g., elastically). The bias force can be overcome by increasing the pressure in the container 104 and thereby increasing the pressure in the flexible container 113. As such when pressure is increased, fluid can flow through the outlet 108 and when pressure is decreased in the container 104, the pinch valve can close and fluid can be restricted from flowing through the outlet 108. As such, fluid can flow through the outlet 108 such that no fluid from the flexible container 113 touches the outlet valve 114 or any other component of the system. In some examples, the outlet valve 114 can include a rubber seal on a first side and a hard sealing surface on a second side such as an O-ring seal, bead, or surface.

In some examples, the outlet valve 114 can be controlled remotely such that the outlet valve 114 can be opened and closed based on direct user input. In some examples where the outlet valve 114 is not mounted in the cap 120, the outlet valve 114 can be an electronically actuated valve that is coupled to a motor. In some examples, the outlet valve 114 can be a manually actuated valve coupled to an actuation mechanism such as a switch or a lever that can be pulled or pressed by a user to move the outlet valve 114 between the open position and the closed position. In some examples, the outlet valve 114 can be a plurality of valves such as a pressure actuated valve that opens when a threshold pressure is applied thereto coupled to a manually actuated valve to operate in conjunction with the pressure-actuated valve. For example, the pressure-actuated valve can be disposed in series with the manually actuated valve to provide a fluid lock during transportation. In some examples, the outlet valve 114 can be a non-powered constant flow valve. In some examples, the threshold pressure can be a pressure from about 5 psi to 30 psi.

In some examples, the dispensing system 100 includes a pressure relief valve 123. The pressure relief valve 123 provides an outlet for the system 100 to release pressurized fluid from the container 104, in the case that the container 104 is excessively pressurized, or if the system 100 is to be reset between dispensing by depressurizing the container 104.

### Bag Receiver

As shown in FIG. 2, in some examples, the container 104 includes a bag receiver 202 disposed inside the container 104 inner volume 110 and/or coupled to the container 104. The bag receiver 202 is provided to hold the flexible container 113 in a desired position within the container 104 inner volume 110. For example, the bag receiver 202 can hold the flexible container 113 in a radially central location when the container 104 is laid on a side of the walls 116. The bag receiver 202 can include a shelf 204 and a u-shaped receiver 206. In some examples, the flexible container 113 can be place on the shelf 204. In some examples, the flexible container 113 can be positioned between the shelf 204 and the wall 116 of the container 104.

The u-shaped receiver 206 can hold an outlet 117 of the flexible container 113 in a fixed position relative to the outlet 108. For example, u-shaped receiver 206 can be configured to fit at least partially around a neck 121 of the flexible container 113 such that the flexible container 113 can slide into a substantially fixed position in the u-shaped receiver 206 in a first direction. A user can slide the neck 121 of the flexible container 113 a second direction opposite the first direction and out of the u-shaped receiver 206 to remove the flexible container 113 from the inner volume 110.

In some examples, the bag receiver 202 can be removably coupled to the container 104 in the inner volume 110. The bag receiver 202 can facilitate insertion of the flexible container 113 into the inner volume 110. As shown in FIG. 6, the flexible container 113 can be coupled to the bag receiver 202 when the bag receiver 202 is not positioned in the inner volume 110. As described above, the u-shaped receiver 206 can be positioned around the neck 121 of the flexible container 113 in order to couple the flexible container 113 to the bag receiver 202. After the flexible container 113 is coupled to the bag receiver 202, the bag receiver 202 and the flexible container 113 can be inserted into the inner volume 110 together. The bag receiver 202 can facilitate removal of the flexible container 113 from the inner volume 110. The bag receiver 202 and the flexible container 113 can be removed from the inner volume 110 with the flexible container 113 coupled to the bag receiver 202.

In some examples, a first bag receiver 202 and a first flexible container 113 can be replaced with a second bag receiver 202 and a second flexible container 113. The first bag receiver 202 and the first flexible container 113 can be removed from the inner volume 110 and the second flexible container 113, coupled to the second bag receiver 202, can be inserted into the inner volume 110.

### Flexible Container

FIG. 1 shows the flexible container 113 disposed in the container 104. The flexible container 113 is provided to retain fluid to be dispensed out of the outlet 108. The flexible container 113 can contain at least one fluid such as liquid drink ingredients such as milk, syrup, water, tea, coffee, or other liquids for serving and/or building beverages. The flexible container 113 is configured to be collapsible such that pressurized air around the flexible container 113 can reduce the volume inside the flexible container 113 and cause fluid to be displaced from the volume inside the flexible container 113. The flexible container 113 can be fluidically sealed such that the flexible container 113 is fluidically isolated from a surrounding volume such as the inner volume of the container 104. For example, the flexible container 113 as shown in FIG. 1 can include a flexible body 115, and an outlet 117, and the neck 121 disposed between the flexible body 115 and the outlet 117. The flexible body 115 defines an interior volume that can contain a fluid. The flexible body 115 can be configured to be manipulated such that the interior volume can be reduced when the flexible body 115 is compressed and fluid therein is pushed out of the outlet 117. In some examples, at least a portion of the neck 121 of the flexible body 115 can be positioned within the outlet 108 and the outlet valve 114 such that the outlet valve 114 surrounds at least a portion of the neck 121 of the flexible body 115. As such, at least a portion of the neck 121 of the flexible body 115 can be substantially concentric with at least a portion of the outlet valve 114. Furthermore, the outlet valve 114 can pinch around a portion of the neck 121 to restrict fluid from flowing therethrough. The flexible container 113 can be made of a flexible material that is configured to retain a fluid therein, such that fluid can be restricted to flow in and out of the outlet 117 when the container 104 is pressurized. For example, the flexible body 115 can be formed from a flexible film material such as plastic or composite fabric or.

### Pressurized Fluid Source

FIG. 1 shows the pressurized fluid source 103. The pressurized fluid source 103 provides fluid to the container 104 to further cause fluid to be dispensed through the outlet 108. The pressurized fluid source 103 can fill the container 104 with fluid thereby compressing the flexible container 113 disposed inside the container 104. The pressurized fluid source 103 is configured to distribute pressurized fluid into the inner volume 110 of the container 104 to increase the pressure in the inner volume 110 to a desired pressure such as the threshold pressure of the outlet valve 114. The pressurized fluid source 103 can be a fluid source that is configured to provide fluid at a greater pressure than the threshold pressure, to ensure that the inner volume 110 can be filled with fluid at least to the threshold pressure. For example, the pressurized fluid source 103 can be a source of pressurized gas or liquid such as a pressurized air cannister, or a fluid pump. In some examples, the pressurized fluid source 103 can be a pressurized mechanism such as a nitrogen generator or a CO2 tank. In some examples, the pressurized fluid source 103 can be a compressor attached to an accumulator, which can feed fluid to one or more containers 104.

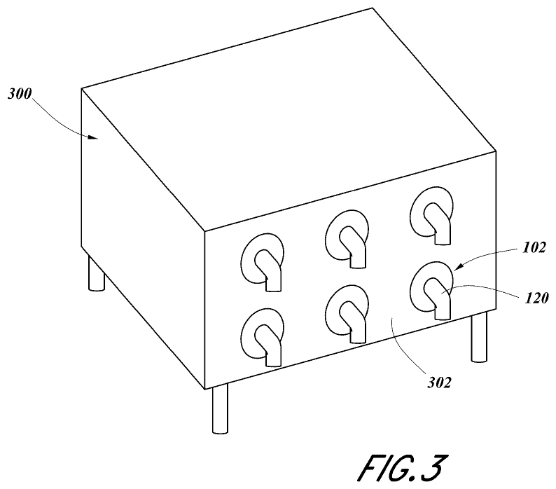

FIG. 3 shows an example fluid dispensing system 300 for distributing a plurality of fluids. In some examples, a plurality of the fluid dispensers 102 can be housed together to form the fluid dispensing system 300. The fluid dispensers 102 can be coupled together in a housing 302 that includes slots to retain the fluid dispensers 102 in place relative to each other. The fluid dispensing system 300 may be configured such that the central axes of the containers 104 (shown in FIG. 1) can be disposed parallel to a ground adjacent the container 104. Further, the containers 104 can be supported by their walls 116 with their caps 120 exposed for a user to open or remove. As such, the flexible containers 113 can be installed and replaced in the containers 104 from a lateral position, and fluids can be dispensed from adjacent fluid dispensers 102.

### Controller

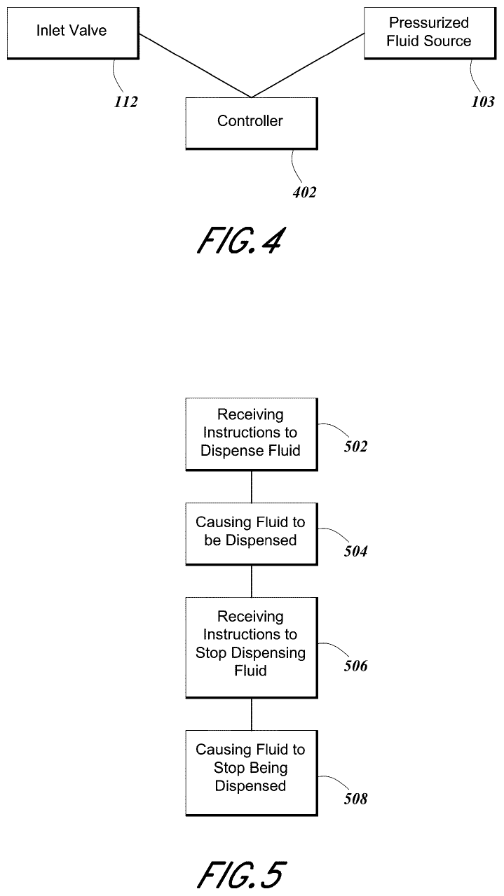

As shown in FIG. 4, in some examples, the system 100 includes a controller 402 that can automate the fluid source 103 and the inlet valve 112 such that pressurized fluid can be distributed into the inner volume 110. In some examples, one or more components of the fluid dispensing system 100 include components that can receive instructions from a processor, such as the controller 402. The processor can be an electronic central controller that includes computer executable instructions to automatically dispense fluid from the fluid dispensing system 100. As shown in FIG. 4, the controller 402 is communicatively coupled to the pressurized fluid source 103 and/or the inlet valve 112. The controller 402 can be configured to cause the pressurized fluid source 103 and/or the inlet valve 112 to execute one or more desired functions. For example, the controller 402 can be configured such that the flow of fluid can be controlled by controlling the amount of pressurized fluid dispensed into the inner volume 110. In some examples, the controller 402 adjusts at least one of the first beverage, the pressurized fluid source 103, and/or the inlet valve 112 based on the instructions received from a machine learning system. In some examples, the controller 402 can coordinate functions of the fluid dispensing system (e.g., beverage distribution system) 100 with other beverage preparation systems and beverage preparation system components.

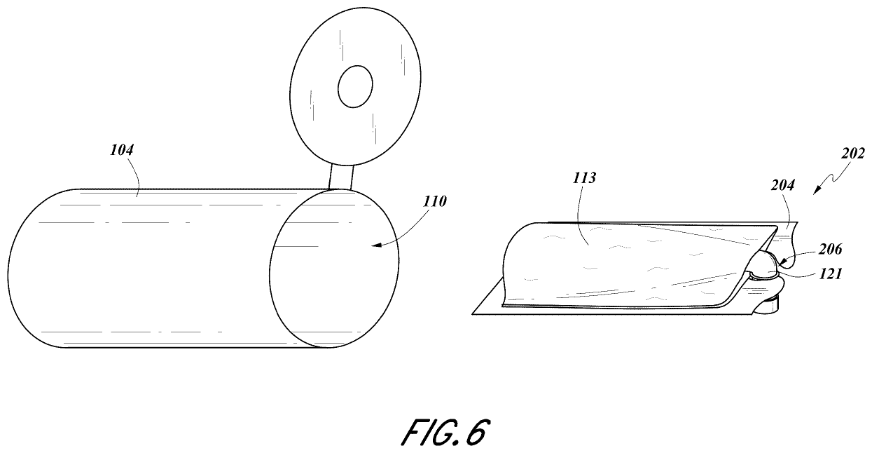

An example method of distributing pressurized fluid is shown in FIG. 5. For example, at 502, the controller 402 can receive instructions to dispense a pressurized fluid. The instructions can be received based on user input or based on an automated or machine learning instruction. In some examples, the instructions are delivered remotely by a user such as a barista or a beverage customer.

At 504, the controller 402 can cause the pressurized fluid to be dispensed at a threshold pressure provided to the inner volume 110 containing the flexible container 113. In some examples, the causing the fluid to be dispensed can include activating a motor to move the inlet valve 112 to the open position to allow pre-charged fluid to enter into the inner volume 110. In some examples, causing the fluid to be dispensed can include activating a fluid pump to dispense pressurized fluid. The pressure can then compress the flexible container 113 and push out the fluid contained therein through the outlet 117 of the flexible container 113. As such, the volume of the flexible container 113 can be decreased as fluid is added from the pressurized fluid source 103. As such, the pressurized fluid source 103 can cause the fluid to be distributed by increasing the pressure to the threshold pressure to move the outlet valve 114 to the open position and push the fluid out of the outlet 117.

At 506, the controller 402 can receive instructions to cause the fluid to stop being disbursed, causing the pressurized fluid to stop being dispensed in the inner volume 110. The instructions can be received based on user input or based on an automated or machine learning instruction. In some examples, the instructions are delivered remotely by a user such as a barista or a beverage customer.

At block 508, the controller 402 can cause the fluid to stop being dispensed. In some examples, the controller 402 can send a signal to activate a motor to move the inlet valve 112 to the closed position to restrict fluid, such as pre-pressurized fluid, from entering into the inner volume 110. The pressure in the inner volume 110 can then fall below the threshold pressure as the flexible container 113 is compressed and takes up less volume in the inner volume 110. Alternatively, or additionally, the controller 402 can stop the fluid from being dispensed, sending a signal to deactivate a fluid pump and thereby stop dispensation of pressurized fluid.

Although certain embodiments have been described herein in connection with flavors, sauces, or syrups for coffee or tea beverages, the systems described herein can be used for any type of ingredient or food product. For example, in some embodiments, the systems herein can be used to deliver fluid or solid ingredients, such as ketchup, mustard, barbecue sauce, cheese sauce, relish, onions, etc. In some embodiments, the systems herein can be used to produce other types of beverages such as sodas, juices, smoothies, milkshakes, etc.

Conditional language used herein, such as, among others, “can,” “might,” “may,” “e.g.,” and the like, unless specifically stated otherwise, or otherwise understood within the context as used, is generally intended to convey that some embodiments include, while other embodiments do not include, certain features, elements, and/or states. Thus, such conditional language is not generally intended to imply that features, elements, blocks, and/or states are in any way required for one or more embodiments or that one or more embodiments necessarily include logic for deciding, with or without author input or prompting, whether these features, elements and/or states are included or are to be performed in any particular embodiment.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently.

The various illustrative logical blocks, modular dispensers, routines, and algorithm steps described in connection with the embodiments disclosed herein can be implemented as electronic hardware, computer software, or combinations of both. To clearly illustrate this interchangeability of hardware and software, various illustrative components, blocks, modular dispensers, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks, devices, and systems in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

While the above detailed description has shown, described, and pointed out novel features as applied to various embodiments, it can be understood that various omissions, substitutions, and changes in the form and details of the devices or algorithms illustrated can be made without departing from the spirit of the disclosure. For example, although different numbers have been used for similar components or features in different figures (e.g., different numbers have been used for the dispenser modules, displays, controllers, etc.), the structural and functional features described in connection with one figure, embodiment, or numbered element may be incorporated into the different-numbered components or features, and vice-versa. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A fluid dispenser comprising:
a container comprising an inlet and an outlet, wherein the container defines an inner volume;
a pressure-actuated outlet valve adjacent the outlet and movable between an open position and a closed position;
a flexible fluid container positioned within the container and including an outlet passage that extends through the pressure-actuated outlet valve; and
a bag receiver positioned in the container, the bag receiver configured to slidably receive at least a portion of the flexible fluid container to secure the outlet of the flexible fluid container relative to the outlet of the container,
wherein the outlet valve is biased toward the closed position and configured to move to the open position when the pressure within the inner volume and applied to the flexible fluid container exceeds a threshold pressure.

2. The fluid dispenser of claim 1, wherein the outlet valve is configured to return to the closed position when the pressure in the inner volume is less than the threshold pressure.

3. The fluid dispenser of claim 1, wherein the outlet passage is disposed in the outlet, such that fluid within the flexible container does not contact the outlet of the container.

4. The fluid dispenser of claim 1, wherein the flexible fluid container further comprises an elongated neck portion.

5. The fluid dispenser of claim 4, wherein the outlet valve is disposed about at least a portion of the neck,
wherein the outlet valve is positioned to restrict fluid flow through at least a portion of the neck.

6. The fluid dispenser of claim 5, wherein the interior volume of the flexible container is in fluidic communication with the outlet when the outlet valve is in the open position, and
wherein the interior volume of the flexible container is fluidically isolated from the outlet when the outlet valve is in the closed position.

7. The fluid dispenser of claim 1, wherein the bag receiver comprises a u-shaped receiver configured to receive at least the portion of the flexible fluid container.

8. The fluid dispenser of claim 7, wherein the bag receiver is removably coupled to the container.

9. The fluid dispenser of claim 1, wherein the inlet of the container is configured to be coupled to a pressurized fluid source.

10. The fluid dispenser of claim 1, wherein the container further comprises an openable cap comprising the outlet.

11. The fluid dispenser of claim 1, further comprising an inlet valve adjacent the inlet.

12. The fluid dispenser of claim 11, wherein the inlet is fluidically sealed when the inlet valve is in the closed position, and wherein the inlet is fluidically open when the inlet valve is in the open position.

13. A fluid dispensing system comprising:
a plurality of container systems, each container system comprising:
a container comprising an inlet and an outlet, wherein the container defines an inner volume;
a pressure-actuated outlet valve adjacent the outlet and movable between an open position and a closed position; and
a bag receiver positioned in the inner volume of the container, the bag receiver configured to slidably receive at least a portion of a flexible container and secure an opening of the flexible container relative to the outlet of the container,
wherein the outlet valve is biased toward the closed position and configured to move to the open position upon receiving a threshold pressure from the inner volume; and
a pressurized fluid source in fluidic communication with the inlet of the container of each container system.

14. The system of claim 13, wherein the outlet valve is configured to return to the closed position upon receiving pressure less than the threshold pressure from the inner volume.

15. The system of claim 13, wherein the outlet is fluidically sealed when the outlet valve is in the closed position, and wherein the outlet is fluidically open when the outlet valve is in the open position.

16. The system of claim 13, wherein the inner volume is in fluidic communication with the outlet when the outlet valve is in the open position, and wherein the inner volume is fluidically isolated from the outlet when the outlet valve is in the closed position.

17. The system of claim 13, further comprising the flexible container defining an interior volume and an opening, wherein the flexible container is disposed inside the inner volume, and wherein the opening is adjacent the outlet of the container.

18. The system of claim 17, wherein the interior volume of the flexible container is in fluidic communication with the outlet when the outlet valve is in the open position, and
wherein the interior volume of the flexible container is fluidically isolated from the outlet when the outlet valve is in the closed position.

19. The system of claim 13, further comprising a processor in communication with the pressurized fluid source.

20. The system of claim 19, further comprising an inlet valve in communication with the processor, wherein the inlet valve is moved between an open position and a closed position based on instructions from the processor.

21. The system of claim 13, wherein the bag receiver of each container system comprises a u-shaped receiver configured to receive at least the portion of the flexible fluid container.
